(19) United States
(12) Patent Application Publication
(10) Pub. No.: US 2023/0121084 A1
(43) Pub. Date: Apr. 20, 2023

(54) SHOCK ABSORBER FOR VEHICLES

(71) Applicant: Honda Motor Co., Ltd., Tokyo (JP)

(72) Inventors: Junichi Suzuki, Royal Oak, MI (US); Fernando M. Rosero, Rochester Hills, MI (US); Eric D. Daume, Plain City, OH (US)

(21) Appl. No.: 17/506,393

(22) Filed: Oct. 20, 2021

(51) Int. Cl. B60N 2/427

(52) U.S. Cl. CPC B60N 2/42709

(57) ABSTRACT

A shock absorber is provided to absorb an impact load in a vehicle. The shock absorber includes a base disposed on a frame of a vehicle. The base has a first part and a second part. The shock absorber further includes a bracket coupled to the base. The bracket includes a first portion with a flat surface and a second portion with an arcuate surface. The first portion is coupled to the first part of the base, and the second portion is coupled to the second part of the base. The shock absorber further includes a cover to enclose the bracket. The cover receives an impact load and transmit the received impact load to at least one of: the first portion or the second portion of the bracket.

### BACKGROUND

Shock absorbers are generally used in a vehicle to protect occupants of the vehicle from a collision of obstacles against the vehicle. The shock absorbers are typically formed from a resilient member (such as leaf springs or coiled springs) and located externally on a chassis of the vehicle. In certain cases, the obstacles may transmit an impact load (such as a shock load) to the vehicle during the collision. In such cases, the shock absorbers may be configured to receive the impact load and dampen the received impact load via the resilient member.

In some instances, there may be severe collisions from the obstacles on the vehicle. During such severe collisions, as typical shock absorbers are located external to the vehicle, the received impact load may be partially dampened by the typical shock absorbers. The impact load, which may not be dampened by the typical shock absorbers, may be transmitted to the specific regions (such as a tibia, an elbow, and the like) of the occupant, which may be discomforting for the occupant of the vehicle.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides a shock absorber. The shock absorber may include a base disposed on a frame of a vehicle. The base may have a first part and a second part. The shock absorber may further include a bracket coupled to the base. The bracket may include a first portion with a flat surface and a second portion with an arcuate surface. The first portion may be coupled to the first part of the base, and the second portion may be coupled to the second part of the base. The shock absorber may further include a cover that may be configured to enclose the bracket. The cover may be configured to receive an impact load and transmit the received impact load to at least one of: the first portion or the second portion of the bracket.

Another exemplary aspect of the disclosure provides a shock absorber. The shock absorber may include a base that may be disposed on a frame of a vehicle. The base may have a first part and a second part. The shock absorber may further include a plurality of brackets that may be coupled to the base. Each bracket of the plurality of brackets may include a first portion with a flat surface and a second portion with an arcuate surface. The first portion of each bracket of the plurality of brackets may be coupled to the first part of the base and the second portion of each bracket of the plurality of brackets may be coupled to the second part of the base. The plurality of brackets may be configured to receive an impact load and transmit the received impact load to the base, via at least one of: the first portion or the second portion of each bracket of the plurality of brackets.

Another exemplary aspect of the disclosure provides a bracket. The bracket may include a base portion having a first end and a second end. The bracket may further include a first portion coupled to the first end of the base portion. The first portion may have a flat surface, which may be configured to extend from the base portion at a first angular orientation. The bracket may further include a second portion coupled to the second end of the base portion. The second portion may have an arcuate surface, which may be configured to extend from the base portion at a second angular orientation. The base portion may be configured to receive an impact load and dampen the received impact load, via at least one of: the first portion or the second portion.

This summary is provided to introduce a selection of concepts in a simplified form that is further disclosed in the detailed description of the present disclosure. This summary is not intended to identify key or essential inventive concepts of the claimed subject matter, nor is it intended for determining the scope of the claimed subject matter.

### BRIEF DESCRIPTION OF THE DRAWINGS

FIG. 1 is an isometric view of an exemplary shock absorber, in accordance with an embodiment of the disclosure.

FIGS. 2A-2B are diagrams that illustrate exemplary scenarios to modify an interstitial spacing between each bracket of the shock absorber of FIG. 1, in accordance with an embodiment of the disclosure.

FIG. 3 is a diagram that illustrates an exemplary scenario to depict a load path of the shock absorber of FIG. 1, in accordance with an embodiment of the disclosure.

FIG. 4 is a diagram that illustrates exemplary configurations of the shock absorber of FIG. 1, in accordance with an embodiment of the disclosure.

FIG. 5 is a flowchart that illustrates an exemplary method to dampen an impact load via the shock absorber of FIG. 1, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may provide a shock absorber for a vehicle to protect an occupant of the vehicle. The shock absorber may include a base that may be disposed on a frame (such as a seat frame) of the vehicle. The shock absorber may further include a bracket that may be coupled to the base and located in an occupant compartment of a vehicle. The bracket may be structurally configured to absorb an impact load that may surpass a shock absorption of typical external shock absorbers. In certain cases, during severe collisions of obstacles against the vehicle, the external shock absorbers may partially absorb the impact load and transmit the remaining impact load to the occupant compartment. The bracket located in the occupant compartment may absorb the remaining impact load that may not be dampened by the external shock absorbers. Based on a location of the bracket in the occupant compartment, the bracket may protect specific regions (such as a tibia, an elbow, and the like) of the occupant, which may improve comfort for the occupant in the vehicle.

The bracket may include a first portion having a flat surface and a second portion having an arcuate surface. The arcuate surface may have an increased surface area, which may improve a load path of the bracket, to absorb the impact load within a limited space of the occupant compartment. In an embodiment, the bracket may also include a reinforcement member, which may be configured to modify the load path of the bracket to further improve the load path within a limited space of the occupant compartment. Based on the improved load path, the bracket may rapidly absorb the impact load and protect the occupant from the impact load.

The shock absorber may further include a cover that may be configured to enclose the bracket. In an embodiment, the cover may be formed from a fabric wrapped plastic material, which may be configured to absorb a part of the impact load and then transmit the remaining impact load to at least one of: the first portion or the second portion of the bracket. Therefore, in addition to the improved load path of the bracket, the cover may facilitate an additional load path for enhanced absorption of the impact load, which may further improve the comfort of the occupant in the vehicle.

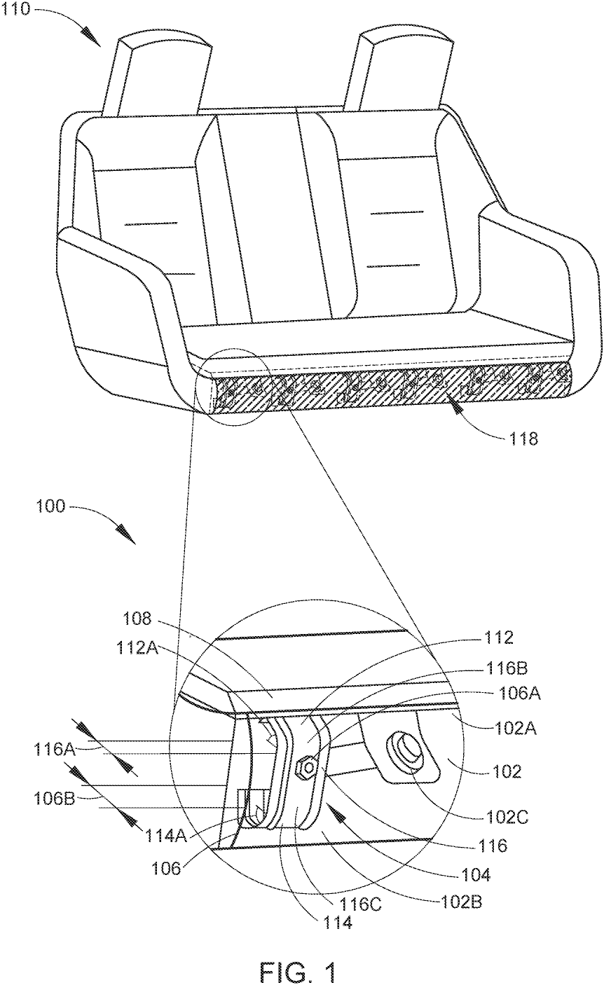

In an embodiment, the shock absorber may include a plurality of brackets to enhance the protection of the occupant. In such embodiment, the cover may have an increased surface area and configured to enclose all of the plurality of brackets and provide a uniformly distributed impact load on each bracket of the plurality of brackets. Therefore, as the cover encloses all the brackets with the increased surface area, even if the impact load is received in a location where the bracket is not installed, the cover may uniformly transmit the impact load to all the brackets for dampening the impact load, irrespective of the location of the bracket. Details of the shock absorber are further described, for example, in FIG. 1.

FIG. 1 is an isometric view of an exemplary shock absorber, in accordance with an embodiment of the disclosure. With reference to FIG. 1, there is shown a shock absorber 100. The shock absorber 100 may include a base 102, a bracket 104 coupled to the base 102, and a cover 106 that may enclose the bracket 104. In an embodiment, the base 102 may be disposed on a frame 108 of a seat assembly 110, which may be associated with a vehicle (not shown). In another embodiment, the base 102 may be disposed in other locations (such as an armrest assembly), which may be associated with the vehicle.

The base 102 may be disposed on the frame 108 of the vehicle and configured to couple the bracket 104 with the frame 108 of the vehicle. For example, the base 102 may have a first side (such as a front side) and a second side (such as a back side). The second side of the base 102 may be disposed on the frame 108 of the vehicle, and the first side of the base 102 may be coupled to the bracket 104. In an embodiment, the base 102 may be a primary supporting structure (such as a substructure) for all components (such as the bracket 104 and the cover 106) of the shock absorber 100.

The base 102 may include a first part 102A and a second part 102B. In an embodiment, the first part 102A and the second part 102B of the base 102 may be coplanar. For example, the base 102 may have a flat structure (such as a two-dimensional structure), such that the first part 102A and the second part 102B may be disposed in a same plane. The flat structure of the base 102 may facilitate a firm grip on to the frame 108 without any wobbling, so that the bracket 104 may be firmly coupled to the base 102 without any vibrational movements.

In another embodiment, the first part 102A and the second part 102B of the base 102 may be disposed in different planes. For example, the base 102 may have a multi-dimensional structure (such as a three-dimensional structure), such that the first part 102A and the second part 102B may be disposed in the different planes. One skilled in the art may understand that the multi-dimensional structure of the base 102 may be based on a structural profile of the bracket 104. For example, in case the bracket 104 has a triangular shape, the base 102 may be structurally configured to accommodate the triangular shape of the bracket 104. In an embodiment, the bracket 104 may be coupled to the base 102, via a bracket fastener 102C. The bracket fastener 102C (as shown in FIG. 1 for example) may be a bolt and a nut fastener. One skilled in the art may understand that there may be various other fasteners (such as a rivet fastener, a latch fastener, a snap-in clip fastener, and the like) that may be deployed as the bracket fastener 102C to couple the bracket 104 with the base 102.

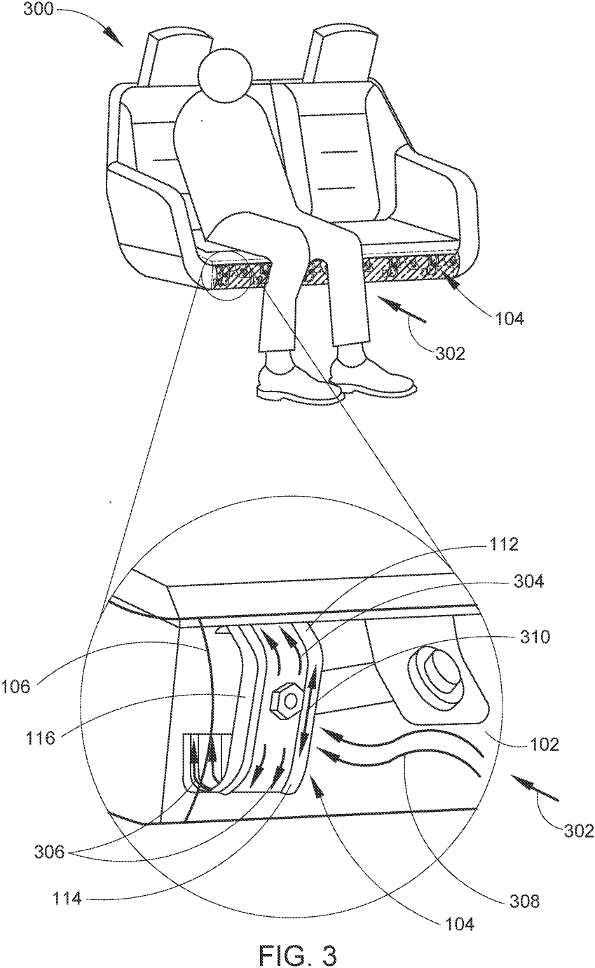

The bracket 104 may be coupled to the base 102 and may be configured to receive the impact load from the collisions of obstacles against the vehicle and dampen the received impact load. For example, the bracket 104 may include an enhanced surface area that may receive the impact load and dampen the received impact load, via a load path of the bracket 104. Details of the load path are further described, for example, in FIG. 3. In an embodiment, the bracket 104 may be coupled to the base 102 of the shock absorber 100. For example, the bracket 104 may be coupled to the second side of the base 102, via the bracket fastener 102C. In another embodiment, the bracket 104 may be directly coupled to the frame 108 of the vehicle, via the bracket fastener 102C. In such cases, as there may not be any additional element between the bracket 104 and the frame 108, there may be a significant reduction in a manufacturing cost of the shock absorber 100. In an embodiment, the bracket 104 may have a first portion 112, a second portion 114, and a base portion 116.

The first portion 112 may include a flat surface that may be configured to receive a part of the impact load and dampen the received impact load. For example, the first portion 112 of the bracket 104 may include an enhanced surface area on the flat surface that may receive the part of the impact load and dampen the received impact load, via a first load path of the first portion 112. Details of the first load path are further described, for example, in FIG. 3. In an embodiment, the first portion 112 of the bracket 104 may be coupled to the first part 102A of the base 102, via a fastening element (not shown), such as a weld joint, a rivet, a nut and bolt mechanism, and the like.

In an embodiment, the first portion 112 may extend from the base portion 116 at a first angular orientation 112A and directly coupled to the first part 102A of the base 102. For example, the first portion 112 may extend at 45 degrees from the base portion 116 and coupled to the first part 102A of the base 102. In another example, the first portion 112 may extend at an angle selected from a range between 5 degrees to 179 degrees from the base portion 116 and coupled to the first part 102A of the base 102. The first angular orientation 112A of the first portion 112 may be selected based on an installation space (such as an installation location) of the bracket 104 in the occupant compartment. For example, in case the installation space is lesser than a required installation space, the first portion 112 may extend from the base portion 116 at an angle lesser than equal to 45 degrees, which may compactly couple the first portion 112 with the first part 102A of the base 102. In another example, in case the installation space is more than the required installation space, the first portion 112 may extend from the base portion 116 at an angle in a range between 46 degrees to 90 degrees, so that the first portion 112 may have an improved load path to dampen the impact load. Details of the improved load path are further described, for example, in FIG. 3.

The second portion 114 may include an arcuate surface that may be configured to receive a part of the impact load and dampen the received impact load. For example, the second portion 114 of the bracket 104 may include an enhanced surface area on the arcuate surface that may receive the part of the impact load and dampen the received impact load, via a second load path of the second portion 114. Details of the second load path are further described, for example, in FIG. 3. In an embodiment, the second portion 114 of the bracket 104 may be coupled to the second part 102B of the base 102, via a fastening element (not shown), such as a weld joint, a rivet, a nut and bolt mechanism, and the like.

In an embodiment, the second portion 114 may extend from the base portion 116 at a second angular orientation 114A and directly coupled to the second part 102B of the base 102. For example, the second portion 114 may extend at 45 degrees from the base portion 116 and coupled to the second part 102B of the base 102. In another example, the second portion 114 may extend at an angle selected from a range between 5 degrees to 179 degrees from the base portion 116 and coupled to the second part 102B of the base 102. The second angular orientation 114A of the second portion 114 may be selected based on the installation space (such as the installation location) of the bracket 104 in the occupant compartment. For example, in case the installation space is lesser than a required installation space, the second portion 114 may extend from the base portion 116 at an angle lesser than equal to 45 degrees, which may compactly couple the second portion 114 with the second part 102B of the base 102. In another example, in case the installation space is more than the required installation space, the second portion 114 may extend from the base portion 116 at an angle in a range between 46 degrees to 90 degrees, so that the second portion 114 may have an improved load path to dampen the impact load. Details of the improved load path are further described, for example, in FIG. 3.

The base portion 116 may include a substantially flat surface that may be configured to receive a part of the impact load and dampen the received impact load. For example, the base portion 116 of the bracket 104 may include an enhanced surface area on the substantially flat surface that may receive the part of the impact load and dampen the received impact load, via the improved load path on one of: the first portion 112 or the second portion 114. Details of the improved load path are further described, for example, in FIG. 3. In an embodiment, the base portion 116 may be located between the first portion 112 and the second portion 114, and coupled to the base 102, via one of: the first portion 112 or the second portion 114.

In an embodiment, the base portion 116 of the bracket 104 may be located at a first distance 116A from the base 102. The first distance 116A may be determined based on the installation space (such as the installation location) of the bracket 104 in the occupant compartment. For example, in case the installation space is lesser than the required installation space, the base portion 116 may be disposed adjacent to the base 102, which may compactly couple the base portion 116 with the base 102, via one of: the first portion 112 or the second portion 114. In another example, in case the installation space is more than the required installation space, the base portion 116 may be disposed distant from the base 102, which may further improve the load path to dampen the impact load. Details of the load path are further described, for example, in FIG. 3.

The base portion 116 may have a first end 116B and a second end 116C. In an embodiment, the first portion 112 may be coupled to the first end 116B of the base portion 116, and the second portion 114 may be coupled to the second end 116C of the base portion. For example, the first portion 112 may be configured to extend at the first angular orientation 112A from the first end 116B of the base portion 116. In another example, the second portion 114 may be configured to extend at the second angular orientation 114A from the second end 116C of the base portion 116.

In an embodiment, the first end 116B and the second end 116C of the base portion 116 may be coplanar. For example, the base portion 116 may have the substantially flat structure (such as a two-dimensional structure), such that the first end 116B and the second end 116C may be disposed in a same plane. The substantially flat structure of the base portion 116 may uniformly transfer the received impact load on the first portion 112 and the second portion 114. Therefore, the substantially flat structure of the base portion 116 provides an equal distribution of the received impact load, which improves a stability of the bracket 104 during the collisions of the vehicle.

In another embodiment, the first end 116B and the second end 116C of the base portion 116 may be disposed in different planes. For example, the base portion 116 may have a multi-dimensional structure (such as a three-dimensional structure), such that the first end 116B and the second end 116C may be disposed in the different planes. One skilled in the art may understand that the multi-dimensional structure of the base portion 116 may be based on the installation space (such as the installation location) of the bracket 104 in the occupant compartment. For example, in case the installation space is lesser than the required installation space, the base portion 116 may be disposed as the two-dimensional structure (such as the substantially flat surface), which may compactly couple the base portion 116 with the base 102, via one of: the first portion 112 or the second portion 114. In another example, in case the installation space is more than the required installation space, the base portion 116 may be disposed as the multi-dimensional structure (such as a corrugated structure), which may be located distant from the base 102 to further improve the load path to dampen the impact load. Details of the load path are further described, for example, in FIG. 3.

In an embodiment, the first portion 112 and the second portion 114 may be located substantially parallel to each other and the base portion 116 may be located between the first portion 112 and the second portion 114 of the bracket 104. The first portion 112 and the second portion 114 may extend from the base portion 116 of the bracket 104 to form a substantially U-shaped profile. Based on the first angular orientation 112A of the first portion 112 and the second angular orientation 114A of the second portion 114, the bracket 104 may also form any other structural profile. Examples of such structural profile of the bracket 104 may include, but are not limited to, a substantially C-shaped profile. In an embodiment, the cover 106 may enclose all components (such as the first portion 112, the second portion 114, and the base portion 116) of the bracket 104.

The cover 106 may be configured to receive the impact load and transmit the received impact load to at least one of: the first portion 112 or the second portion 114 of the bracket 104. For example, the cover 106 may include an increased surface area that may enclose all the components of the shock absorber 100 and provide a uniformly distributed impact load on each component of the shock absorber 100. Therefore, irrespective of a location of the bracket 104 and the base 102, the cover 106 may uniformly transmit the received impact load to all the components of the shock absorber 100. In an example, the cover 106 may have a first section (not shown) and a second section (not shown). The first section of the cover 106 that may enclose the first part 102A of the base 102 and the first portion 112 of the bracket 104. The second section of the cover 106 may enclose the second part 102B of the base 102 and the second portion 114 of the bracket 104. In another embodiment, the cover 106 may encapsulate the bracket 104 at one side (such as a front side) and the base 102 may encapsulate the bracket 104 on other side (such as a back side). For example, the base 102 may substantially enclose the first portion 112 and the second portion 114 of the bracket 104, and the cover 106 may enclose the base portion 116 of the bracket 104.

The cover 106 may be coupled to the base portion 116 of the bracket 104, via a cover fastener 106A. The cover fastener 106A shown in FIG. 1 may be, for example, a bolt and a nut fastener. One skilled in the art may understand that there may be various other fasteners (such as a rivet fastener, a latch fastener, a snap-in clip fastener, and the like) that may be deployed as the cover fastener 106A to couple the cover 106 with the base portion 116 of the bracket 104. In another embodiment, the cover 106 may have a substantially C-shaped profile, which may be configured to be in a flushed surface with the seat assembly 110 of the vehicle. For example, the substantially C-shaped profile of the cover 106 may mate with components of the seat assembly 110, such that a datum level (such as a height or a length) of the cover 106 may be in flush with the datum level (such as a height or a length) of the components of the seat assembly 110, to aesthetically improve a visual appearance of the occupant compartment. The cover 106 may also have any other structural profile, such as (but not limited to) a substantially D-shaped profile, a corrugated profile, and the like.

The cover 106 may be disposed in a plane that may be substantially parallel to a plane of the base 102. In an embodiment, the cover 106 may be disposed at a second distance 106B from the base 102. The second distance 106B may be determined based on the installation space (such as the installation location) of the bracket 104 in the occupant compartment. For example, in case the installation space is lesser than the required installation space, the cover 106 may be disposed adjacent to the base 102 and compactly couple the bracket 104 with the base 102, via the cover fastener 106A. In another example, in case the installation space is more than the required installation space, the cover 106 may be disposed distant from the base 102 and coupled via the cover fastener 106A, to further improve the load path to dampen the impact load to the frame 108, via the bracket 104. In an embodiment, the cover 106 may be formed from a fabric wrapped plastic material, to further enhance the load path of the impact load. For example, cover 106 may be made of a plastic material and adhesively wrapped with at least one of: a single-layer fabric material or a multi-layer fabric material, to absorb a part of the impact load and then transmit rest of the impact load to at least one of: the first portion 112 or the second portion 114 of the bracket 104. Therefore, in addition to the improved load path of the bracket 104, the cover 106 may facilitate an additional load path for enhanced absorption of the impact load, which may further improve the comfort of the occupant of the vehicle. Details of the load path are further described, for example, in FIG. 3. In an embodiment, the cover 106 may enclose both the first portion 112 and the second portion 114 of the bracket 104 that may be located substantially perpendicular to the frame 108 of the vehicle, for the transmission of the impact load.

The frame 108 may have a provision to couple with the base 102 of the shock absorber 100. Examples of the provision may include, but not limited to, a hole or a slot. Based on a location of the provision of the frame 108, the base 102 may be coupled with the frame 108, via a suitable fastening arrangement. The fastening arrangement may include a bolt and a nut fastener that may couple the base 102 of the shock absorber 100 with the provision of the frame 108. One skilled in the art may understand that there may be various other fastening mechanisms (such as a rivet fastener, a latch fastener, a snap-in clip fastener, or even a welded joint, and the like) that may be deployed as the fastening arrangement to couple the base 102 with the frame 108 of the vehicle. The frame 108 may be a part of a component of the vehicle. For example, the frame 108 may be a part of the seat assembly 110. The seat assembly 110 may include a seat for the occupant, to improve the comfort of the occupant during travel using the vehicle. In an embodiment, the frame 108 may be disposed beneath the seat assembly 110 and the base 102 of the shock absorber 100 is coupled to the frame 108 to protect a leg (such as a tibia) of the occupant.

In operation, the cover 106 may receive the impact load and transmit the received impact load to at least one of: the first portion 112 or the second portion 114 of the bracket 104. In an embodiment, the cover 106 may transmit the received impact load to the base portion 116 of the bracket 104. The bracket 104 may absorb the impact load that may surpass from typical external shock absorbers. For example, in case of severe collisions of the vehicle, the external shock absorbers may partially absorb the impact load and transmit the remaining impact load to the occupant compartment. The bracket 104 may absorb the remaining impact load that may not be dampened by the external shock absorbers. Based on a location of the bracket 104 in the occupant compartment, the bracket 104 may protect specific regions (such as a tibia, an elbow, and the like) of the occupant, which may improve comfort for the occupant. In another embodiment, the cover 106 may transmit the received impact load directly to the base 102 of the shock absorber 100. Details of the transmission of the impact load are further described, for example, in FIG. 3.

In some instances, there may be more than one occupant in the vehicle. In such cases, the shock absorber 100 may include a plurality of brackets (for example, more than one bracket, which may be identical to the bracket 104) that may be coupled to the base 102, to protect each occupant of the vehicle. Each bracket (such as the bracket 104) of the plurality of brackets may include the first portion 112 that may have the flat surface and the second portion that may have the arcuate surface. The first portion 112 of each bracket (such as the bracket 104) of the plurality of brackets may be coupled to the first part 102A of the base 102. Further, the second portion 114 of each bracket (such as the bracket 104) of the plurality of brackets may be coupled to the second part 102B of the base 102. Based on the coupling between the plurality of brackets and the base 102, the plurality of brackets may receive an impact load and transmit the received impact load to the base 102, via at least one of: the first portion 112 or the second portion 114 of each bracket (such as the bracket 104) of the plurality of brackets. Details of the transmission of the impact load are further described, for example, in FIG. 3.

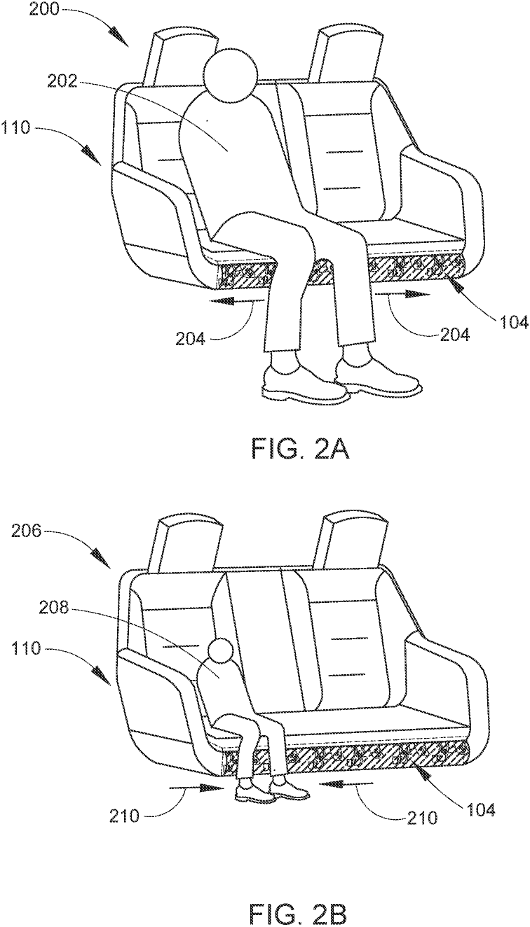

In an embodiment, the cover 106 may be configured to enclose the plurality of brackets. The cover 106 may be further configured to receive the impact load and transmit the received impact load to at least one of: the first portion 112 or the second portion 114 of each bracket of the plurality of brackets, based on occupant information. The occupant information may relate to at least one of: a location of occupant, or a number of occupants on the seat assembly 110. Details of the occupant information are further described, for example, in FIGS. 2A-2B.

In another embodiment, each bracket (such as the bracket 104) of the plurality of brackets may be separated at an interstitial spacing. The interstitial spacing may relate to a gap (such as a space) between two consecutive brackets in the plurality of brackets. In certain cases, the shock absorber 100 may be configured to modify the interstitial spacing between each bracket of the plurality of brackets, based on the occupant information. In an example, each bracket (such as the bracket 104) of the plurality of brackets may be horizontally aligned and coupled to the base 102 at a coupling location 118, which may be located substantially below the seat assembly 110 of the vehicle. Further, each bracket of the plurality of brackets may be configured to modify the coupling location 118 based on the occupant information. In another example, each bracket (such as the bracket 104) of the plurality of brackets may be vertically aligned and coupled to the base 102 at the coupling location 118, which may be located substantially below the seat assembly 110 of the vehicle. Further, each bracket of the plurality of brackets may be configured to modify the coupling location 118 based on the occupant information. Details of the occupant information are further described, for example, in FIGS. 2A-2B. It may be noted that six number of the plurality of brackets shown in FIG. 1 is presented merely as an example. In certain situations, the number of the plurality of brackets may be less than or more than six, based on different factors (such as, but not limited to, size of seat assembly 110, occupant information, or a decision of a manufacturer of the vehicle), without any deviation from scope of the disclosure.

FIGS. 2A-2B are diagrams that illustrate exemplary scenarios to modify an interstitial spacing between each bracket of the shock absorber of FIG. 1, in accordance with an embodiment of the disclosure. FIGS. 2A-2B are explained in conjunction with elements from FIG. 1. With reference to FIGS. 2A-2B, there is shown the bracket 104 that may be coupled to the base 102 (shown in FIG. 1) at the coupling location 118, which may be located substantially below the seat assembly 110 of the vehicle. Based on the occupant information, the bracket 104 may be configured to modify the coupling location 118.

Referring to FIG. 2A, there is shown a first exemplary scenario 200 of the shock absorber 100. In the first exemplary scenario 200, there may be a first object 202 that may be disposed on the seat assembly 110. The first object 202 may be an occupant, who may be an adult person having a leg profile larger than an average adult person. In such scenario, the occupant information (such as, but not limited to, the leg profile of the adult person, a number of adult persons, or a location of the adult person on the seat assembly 110) may be determined, and based on the determined occupant information, the bracket 104 may be configured to modify the coupling location 118. For example, the bracket 104 may be moved along the first direction 204 to modify the coupling location 118 from a default location to a first location, so that the first location of the bracket 104 could be in-line with a location of the leg profile of the adult person. Based on the modified location of the bracket 104, the bracket 104 may be able to damp the impact load experienced by the adult person and may protect a leg (such as a tibia) of the adult person, via a suitable load path, even during severe collisions of the vehicle. Details of the load path are further described, for example, in FIG. 3.

Referring to FIG. 2B, there is shown a second exemplary scenario 206 of the shock absorber 100. In the second exemplary scenario 206, there may be a second object 208 that may be disposed on the seat assembly 110. The second object 208 may be an occupant, who may be a child person having a leg profile smaller than an average adult person. In such scenario, the occupant information (such as, but not limited to, the leg profile of the child person, a number of child persons, or a location of the child person in the seat assembly 110) may be determined, and based on the determined occupant information, the bracket 104 may be configured to modify the coupling location 118. For example, the bracket 104 may be moved along the second direction 210 to modify the coupling location 118 from the default location to a second location, so that the second location of the bracket 104 could be in-line with a location of the leg profile of the child person (i.e. occupant of the vehicle). Based on the modified location of the bracket 104, the bracket 104 may be able to damp the impact load experienced by the child person and may protect a leg (such as a tibia) of the child person, via a suitable load path, even during severe collisions of the vehicle. Details of the load path are further described, for example, in FIG. 3.

FIG. 3 is a diagram that illustrates an exemplary scenario to depict a load path of the shock absorber of FIG. 1, in accordance with an embodiment of the disclosure. FIG. 3 is explained in conjunction with elements from FIG. 1 and FIGS. 2A-2B. With reference to FIG. 3, there is shown an exemplary scenario 300 to depict a load path of the shock absorber 100 based on an impact load 302 of a collision on the vehicle. The impact load 302 may be caused from an obstacle (not shown), which may collide against the vehicle. The obstacle may include, but not limited to, a secondary vehicle that may crash with the vehicle of the occupant, or any other object (such as a rock, a tree, and the like) that may be located adjacent to the road, which may be crashed by the vehicle of the occupant.

In operation, the cover 106 may be configured to transmit the impact load received from the obstacle to at least one of: the first portion 112 and the second portion 114, to dampen the received impact load, via the base 102. For example, the first portion 112 may form a first load path 304 and the second portion 114 may form a second load path 306, to dampen the received impact load, via the base 102. In an embodiment, the bracket 104 may have a pair of protruding beads to guide and tune at least one of: the first load path 304 or the second load path 306, to dampen the received impact load, via the base 102.

The first load path 304 may indicate a first direction in which each consecutive impact load may pass through the first portion 112 of the bracket 104. The first load path 304 may be formed via the flat surface of the first portion 112, to dampen a part of the received impact load. The second load path 306 may indicate a second direction in which each consecutive impact load may pass through the second portion 114 of the bracket 104. The second load path 306 may be formed via the arcuate surface of the second portion 114, to dampen a part of the received impact load. In an embodiment, the second load path 306 formed via the arcuate surface of the second portion 114 may be longer and may provide a maximum energy absorption as compared to an energy absorption provided by the first load path 304 formed via the flat surface of the first portion 112.

In another embodiment, the cover 106 may be further configured to form a third load path 308 (as shown, for example, in FIG. 3) to dampen a part of the received impact load, via the fabric wrapped plastic material of the cover 106. For example, the cover 106 may form the third load path 308 to dampen the received impact load, based on the at least one of: the single-layer fabric material or the multi-layer fabric material that may be wrapped to the cover 106. In an embodiment, the third load path 308 of the cover 106 formed from the single-layer fabric wrapped material may be shorter and may provide a minimal energy absorption as compared to an energy absorption provided by the third load path 308 of the cover 106 formed from the multi-layer fabric wrapped material.

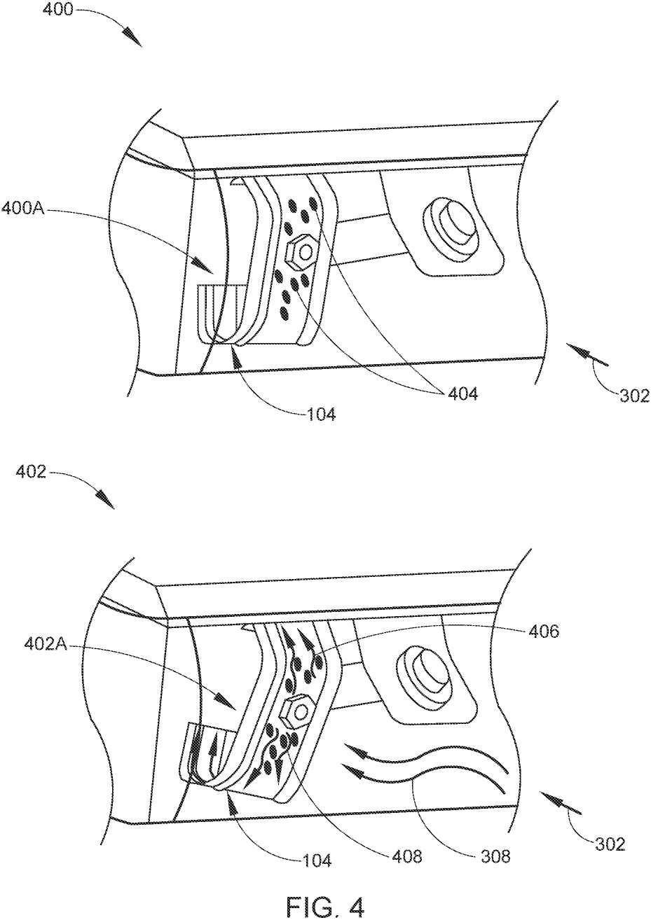

In yet another embodiment, the base portion 116 may be further configured to form a base load path 310 (as shown, for example, in FIG. 3) to partially dampen the received impact load and then transmit the remaining impact load to at least one of: the first portion 112 or the second portion 114. In operation, the cover 106 may receive the impact load and absorbs a first part of the received impact load, via the third load path 308. The cover 106 may transmit rest of the received impact load to the base portion 116. The base portion 116 may receive the impact load from the cover 106 and may absorb a second part of the received impact load, via the base load path 310. The base portion 116 may further transmit rest of the received impact load to at least one of: the first portion 112 or the second portion 114. The first portion 112 may receive the impact load from the base portion 116 and may absorb a third part of the received impact load, via the first load path 304. The second portion 114 may receive the impact load from the base portion 116 and may absorb a fourth part of the received impact load, via the second load path 306. The base 102 may be further configured to receive the remaining part of the impact load from one of: the first portion 112 or the second portion 114, and completely absorb the remaining impact load and protect the occupant of the vehicle from the impact load of the collisions. Because of the absorption of the impact load, the bracket 104 may deform from a default structure. Details of the deformation of the bracket 104 is further described, for example, in FIG. 4.

FIG. 4 is a diagram that illustrates exemplary configurations of the shock absorber of FIG. 1, in accordance with an embodiment of the disclosure. FIG. 4 is explained in conjunction with elements from FIG. 1, FIGS. 2A-2B, and FIG. 3. With reference to FIG. 4, there is shown exemplary configurations of the shock absorber 100. The exemplary configurations may include an initial configuration 400 and an impact configuration 402.

In the initial configuration 400, the bracket 104 may be located at a first position 400A. The bracket 104 further comprises a reinforcement member 404 to modify at least one of: the first load path 304 or the second load path 306 (i.e. shown in FIG. 3). In an embodiment, the reinforcement member 404 may be impregnated in at least one of: the first portion 112 or the second portion 114 of the bracket 104 to modify a load transmission path of the bracket 104.

In the impact configuration 402, The bracket 104 may be deformed to a second position 402A from the first position 400A. In an embodiment, based on the transmission of the impact load, the bracket 104 may be configured to deform from the first position 400A to the second position. 402A. During deformation, the load transmission path of the bracket 104 may be plotted to indicate a rate of shock absorption of the shock absorber 100. In an example, the first portion 112 (shown in FIGS. 1 and 3) may be impregnated with the reinforcement member 404 to form a first reinforced load path 406. The first reinforced load path 406 may absorb more impact compared to the first load path 304. In another example, the second portion 114 (shown in FIGS. 1 and 3) may be impregnated with the reinforcement member 404 to form a second reinforced load path 408. The second reinforced load path 408 may absorb more impact compared to the second load path 306. In yet another example, the reinforcement member 404 may also be impregnated in the base portion 116 (shown in FIGS. 1 and 3) of the bracket 104 to improve the base load path 310 (shown in FIG. 3). In yet another example, the reinforcement member 404 may also be impregnated in the cover 106 (shown in FIGS. 1 and 3) of the shock absorber 100 to further improve the third load path 308. For example, the cover 106 may include an expandable polypropylene (EPP) or a polypropylene (PP) foam as the reinforcement member 404 to improve the third load path 308 and enhance safety of the occupant in the occupant compartment of the vehicle.

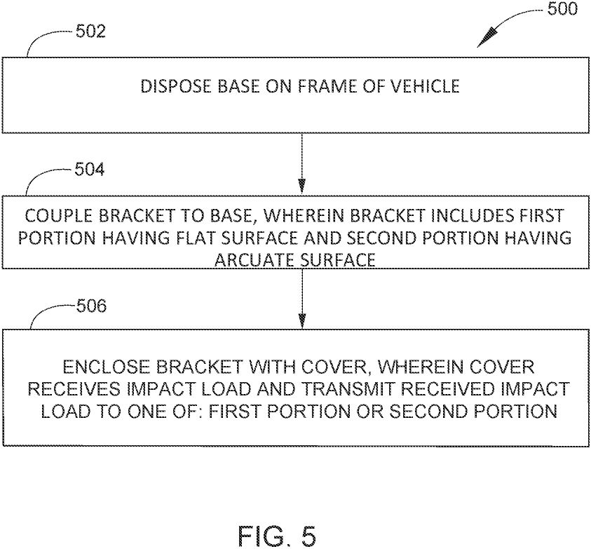

FIG. 5 is a flowchart that illustrates an exemplary method to dampen an impact load via the shock absorber of FIG. 1, in accordance with an embodiment of the disclosure. FIG. 5 is explained in conjunction with elements from FIGS. 1, 2A-2B, 3, and 4. With reference to FIG. 5, there is shown a flowchart 500 that depicts a method to dampen the impact load 302 via the shock absorber 100. The method illustrated in the flowchart 500 may start from 502.

At 502, the base 102 may be disposed on a frame 108 of the vehicle. In an embodiment, an operator may dispose the base 102 on the frame 108 of the vehicle, via the suitable fastening arrangement, as described, for example, in FIG. 1.

At 504, the bracket 104 may be coupled to the base 102. The bracket 104 may include the first portion 112 having the flat surface and the second portion 114 having the arcuate surface. In an embodiment, the operator may couple the bracket 104 with the base 102, as described, for example, in FIG. 1.

At 506, the cover 106 may be enclosed to the bracket 104. The cover 106 may receive the impact load 302 and transmit the received impact load 302 to at least one of: the first portion 112 or the second portion 114, as described, for example, in FIGS. 1, 2A-2B, 3, and 4. Control may pass to end.

The flowchart 500 is illustrated as discrete operations, such as 502, 504, and 506. However, in certain embodiments, such discrete operations may be further divided into additional operations, combined into fewer operations, or eliminated, or rearranged depending on the implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader’s understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A shock absorber, comprising:
a base disposed on a frame of a vehicle, wherein the base has a first part and a second part;
a bracket coupled to the base, wherein the bracket comprises a first portion having a flat surface and a second portion having an arcuate surface, and wherein the first portion is coupled to the first part of the base and the second portion is coupled to the second part of the base; and
a cover configured to enclose the bracket,
wherein the cover is configured to receive an impact load and transmit the received impact load to at least one of: the first portion or the second portion of the bracket.

2. The shock absorber according to claim 1, wherein the bracket is coupled to the base at a coupling location, which is substantially below a seat assembly of the vehicle, and wherein the bracket is configured to modify the coupling location based on occupant information.

3. The shock absorber according to claim 1, wherein the first portion and the second portion are located substantially parallel to each other,
wherein the bracket further comprises a base portion that is located between the first portion and the second portion of the bracket, and
wherein the first portion and the second portion extend from the base portion of the bracket to form a substantially U-shaped profile.

4. The shock absorber according to claim 3, wherein the base portion of the bracket is located at a first distance from the base, and wherein the first portion and the second portion of the bracket are directly coupled to the base.

5. The shock absorber according to claim 3, wherein the base encloses the first portion and the second portion of the bracket, and the cover encloses the base portion of the bracket, and
wherein the cover is configured to transmit the received impact load to at least one of: the first portion and the second portion, to dampen the received impact load, via the base.

6. The shock absorber according to claim 1, wherein the first portion forms a first load path and the second portion forms a second load path, to dampen the received impact load, and
wherein the second load path formed via the arcuate surface of the second portion is longer than the first load path formed via the flat surface of the first portion.

7. The shock absorber according to claim 1, wherein the cover is formed from a fabric wrapped plastic material, and
wherein the cover is further configured to form a third load path to dampen the received impact load, via the fabric wrapped plastic material.

8. The shock absorber according to claim 1, wherein the cover is wrapped with at least one of: a single-layer fabric material or a multi-layer fabric material, and
wherein the cover is further configured to form a third load path to dampen the received impact load, based on the at least one of: the single-layer fabric material or the multi-layer fabric material wrapped to the cover.

9. The shock absorber according to claim 1, wherein the bracket further comprises a reinforcement member, and
wherein the reinforcement member is impregnated in at least one of: the first portion or the second portion of the bracket to modify a load transmission path of the bracket.

10. The shock absorber according to claim 1, wherein, based on a transmission of the impact load, the bracket is configured to deform from a first position to a second position.

11. The shock absorber according to claim 1, wherein the first portion and the second portion are located substantially perpendicular to the frame of the vehicle.

12. The shock absorber according to claim 1, wherein the first part and the second part of the base are coplanar.

13. The shock absorber according to claim 1, wherein the cover is disposed in a plane that is substantially parallel to a plane of the base, and
wherein the cover is disposed at a second distance from the base.

14. A shock absorber, comprising:
a base disposed on a frame of a vehicle, wherein the base has a first part and a second part; and
a plurality of brackets coupled to the base, wherein each bracket of the plurality of brackets comprises a first portion having a flat surface and a second portion having an arcuate surface,
wherein the first portion of each bracket of the plurality of brackets is coupled to the first part of the base and the second portion of each bracket of the plurality of brackets is coupled to the second part of the base, and
wherein the plurality of brackets are configured to receive an impact load and transmit the received impact load to the base, via at least one of: the first portion or the second portion of each bracket of the plurality of brackets.

15. The shock absorber according to claim 14, wherein each bracket of the plurality of brackets is separated at an interstitial spacing, and
wherein the shock absorber is configured to modify the interstitial spacing between each bracket of the plurality of brackets, based on occupant information.

16. The shock absorber according to claim 14, further comprising a cover configured to enclose the plurality of brackets,
wherein the cover is configured to receive the impact load and transmit the received impact load to at least one of: the first portion or the second portion of each bracket of the plurality of brackets.

17. The shock absorber according to claim 14, wherein each bracket of the plurality of brackets is horizontally aligned and coupled to the base at a coupling location, which is substantially below a seat assembly of the vehicle, and
wherein each bracket of the plurality of brackets is configured to modify the coupling location based on occupant information.

18. The shock absorber according to claim 14, wherein each bracket of the plurality of brackets is vertically aligned and coupled to the base at a coupling location, which is substantially below a seat assembly of the vehicle, and
wherein each bracket of the plurality of brackets is configured to modify the coupling location based on occupant information.

19. A bracket, comprising:
a base portion having a first end and a second end;
a first portion coupled to the first end of the base portion, wherein the first portion has a flat surface, which is configured to extend from the base portion at a first angular orientation; and
a second portion coupled to the second end of the base portion, wherein the second portion has an arcuate surface, which is configured to extend from the base portion at a second angular orientation,
wherein the base portion is configured to receive an impact load and dampen the received impact load, via at least one of: the first portion or the second portion.

20. The bracket according to claim 19, wherein the first portion that extends at the first angular orientation is substantially parallel to second portion that extends at the second angular orientation, and
wherein the first portion and the second portion extend from the base portion of the bracket to form a substantially U-shaped profile.
